(19) United States
(12) Patent Application Publication
(10) Pub. No.: US 2004/0031023 A1
(43) Pub. Date: Feb. 12, 2004

(54) Compilation of declarations, expressions, and statements of dynamic classification in object-oriented programs, and apparatus that interprets the declarations, expressions, and statements of dynamic classification

(76) Inventor: Liwu Li, Windsor (CA)

Correspondence Address: Liwu Li, 1608 St. Clair Ave, Windsor, ON, N9B 3L1, CA

(21) Appl. No.: 10/216,957

(22) Filed: Aug. 12, 2002

(51) Int. Cl. G06F 9/45

(52) U.S. Cl. 717/140; 717/139

(57) ABSTRACT

Dynamic role acquisition and relinquishing by real-world entities cannot be coded in prior programming and database languages. The invented compilation and apparatus support coding real-world role acquisition and relinquishing in object-oriented program and database system. They compile and interpret, respectively, the code of dynamic classification.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invented compilation and apparatus pertain to fields of object-oriented programming and object-oriented database system.

In the real world, an entity such as a person may dynamically assume and relinquish roles such as student, graduate student, employee, and manager. But, the prior compilation techniques and interpreters for object-oriented programs and object-oriented databases do not support reclassifying an object created with a class into other classes. The prior compilation techniques and interpreters do not allow a programmer to code the dynamic classification relation between real-world concepts in an object-oriented program or database schema. For example, in the prior object-oriented programming and database languages, an object created with class Person cannot be reclassified into class Student, GraduateStudent, Employee, or Manager. The dynamic classification relation between real-world concepts person, student, graduate student, employee, and manager cannot be coded between classes Person, Student, GraduateStudent, Employee, and Manager in an object-oriented program or database schema.

The problem to be solved with the invented compilation and apparatus is how object-oriented programmers can fulfill the following tasks in object-oriented programs and database systems:

(1) Declare dynamic classification relation between classes,,

(2) Dictate role acquisition to objects,

(3) Dictate role relinquishing to objects,

(4) Store and visit data in roles, and

(5) Invoke functions defined for roles.

The inventions support the above new features of object-oriented programs and databases. They enable computers and database systems to

(i) Store and manage dynamic classification relation between classes,

(ii) Store and manage roles acquired by objects,

(iii) Execute expressions and statements that store and access data in roles, and

(iv) Execute functions invoked for roles.

### BRIEF SUMMARY OF THE INVENTION

The invented compilation and apparatus extend the prior compilation techniques and interpreters for object-oriented programs and databases. They support object-oriented programmers to

(1) Specify dynamic classification relation between classes,

(2) Classify and declassify objects into/from classes dynamically,

(3) Instantiate classes to create roles as well as objects,

(4) Use roles to store data, and

(5) Invoke functions for roles to execute.

The following description of the inventions specifies

(i) How to store and manage the dynamic classification relation in memory and in database,

(ii) How to apply the stored dynamic classification relation between classes,

(iii) How to store and manage roles, and

(iv) How to apply the roles.

### BRIEF DESCRIPTION OF THE SEVERAL VIEWS OF THE DRAWINGS

Two drawings are used to illustrate applications of the inventions:

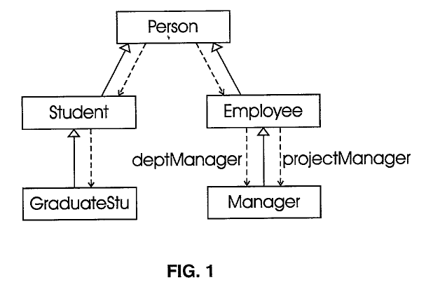

(1) FIG. 1 shows a UML class diagram extended with dynamic classification relation between classes. It visually shows

(i) Dynamic classification relation between real-world concepts,

(ii) Dynamic classification relation between classes in an object-oriented program or database schema, and

(iii) Dynamic classification relation to be loaded, managed, and applied by the binary code generated with the invented compilation and by the invented apparatus.

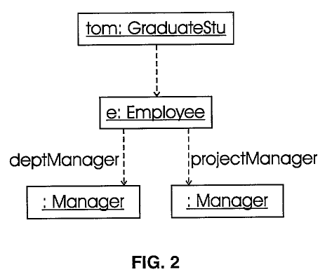

(2) FIG. 2 is a UML object diagram extended with parent-child links between objects. It visually depicts

(i) A primary object that represents a real-world entity uniquely,

(ii) Roles that are currently played or assumed by the entity,

(iii) Dynamic objects created for representing the roles, and

(iv) Parent-child relation that is created, managed, and used by the binary code generated with the invented compilation and by the invented apparatus.

The invented compilation and apparatus can be applied to compile and interpret, respectively, an object-oriented program extended with dynamic classification functionality, which applies the metadata at class level mentioned in Item (1.iii) to manage the parent-child relation at object level mentioned in Item (2.iv).

### DETAILED DESCRIPTION OF THE INVENTION

Term Definitions

(1) Term normal object-oriented program or simply normal program for a software or database system means a program written in the prior art of object-oriented programming. A normal program does not code dynamic classification relation at class level or allow objects to acquire roles dynamically. Term extended object-oriented program or simply extended program refers to a normal program that is extended with Features (1)-(5) described in Section 6 for a software or database system.

(2) Term normal language refers to a prior object-oriented programming or database language, which does not support a programmer to code Features (1)-(5) described in Section 6. Term extended language refers to a normal language that is extended for dynamic classification. The extensions are described with grammar rules for supporting Features (1)-(5) described in Section 6. The grammar rules are presented in the following subsections.

(3) Term normal compilation technique means a prior compilation technique, which compiles only normal object-oriented programs. Term normal interpreter means a prior interpreter of normal object-oriented programs. The invented compilation technique and apparatus handle Features (1)-(5) described in Section 6 for extended object-oriented programs.

The following five subsections correspond to Features (1)-(5) described in Section 6. Each subsection describes

(i) An interesting aspect of real-world dynamic classification,

(ii) How to extend a normal language with a new feature by which the above dynamic classification aspect can be coded in an extended program, and

(iii) How the invented compilation compiles the new feature in an extended program to executable binary code that realizes the dynamic classification aspect, and how the invented apparatus interprets the new feature in an extended program.

Extensions to normal programs mentioned in Step (ii) are specified with grammar rules. In the following grammar rules,

A component enclosed by a pair of matching symbols [and] * is optional,

A component enclosed by a pair of matching symbols {and} * is repeated zero or multiple times,

An identifier limited by symbols <and > denotes a nonterminal symbol,

A bar symbol | separates alternative components,

Symbol ::=separates a nonterminal symbol and its definition, and

All other symbols are keywords or terminal symbols.

Dynamic Classification Relation

In the real world, instances of some concepts can assume roles represented by instances of concepts. Dynamic classification relation abstracts the role-assuming relationships at concept level. For example, since a person can play or assume a student role, concepts person and student are related by dynamic classification relation. The concepts person and student are usually represented with classes Person and Student in a normal object-oriented program. The classes should be related with dynamic classification relation in the extended program.

A programmer declares dynamic classification relation in class definitions by following grammar rules:

| | |
|---|---|
| C1: | <class_definition> ::= class <class_name> [ <staticparents> ] * |

[ <dynamic_classification> ] * <class_body>

| | |
|---|---|
| C2: | <class_name> ::= <identifier> |
| C3: | <static_parents> ::= extends <class_names> |
| C4: | <dynamic_classification> ::= dynamic <class_names> |

[ <label_lists> ] *

| | |
|---|---|
| C5: | <class_names> ::= <class_name> {, <class_name> } * |
| C6: | <label_lists> ::= label [ <label_list> ] {, [ <label_list> ] } * |
| C7: | <label_list> ::= <identifier> {, <identifier> } * |

In the above grammar rules, class, extends, dynamic, and label are keywords. The rules extend the definition of a class C in a normal program with an optional dynamic clause, which is introduced with keyword dynamic, and an optional label clause, which is introduced with keyword label. Keyword extends introduces static superclasses S1, . . . , Sk of the defined class C, which inherits and is a static subclass of classes S1, . . . , Sk. The extends clause specifies inheritance relation between classes. Different programming and database languages may present class inheritance relation in different syntax. But, the differences in presentation do not affect the specification or applicability of the invented compilation and apparatus, which depend on a prior technique to handle class inheritance relation.

In the definition of class C, keyword dynamic introduces dynamic subclasses C1, . . . , Cm of class C, which is a dynamic superclass of classes C1, . . . , Cm. Keyword label introduces identifier lists L1, . . . , Ln with m≧n>0. Each list Li is enclosed with square brackets [and]. An identifier l in list Li contributes tuple <c, l, ci> for dynamic classification relation, which will be denoted with symbol X. For each integer i with n<i≦m, the class definition contributes tuple <c, ci, Ci> for X with default label ci, which is same as dynamic subclass name Ci except that the initial letter of the default label is in lowercase. For example, tuple <Person, employee, Employee> in dynamic classification relation X indicates that a person can assume an employee role. The label employee is a default label derived from class name Employee.

The dynamic classification relation X specified by an extended object-oriented program consists of tuples in format <c, l, ci>. A semantic restriction on relation X is that a class C and an identifier l uniquely identify at most one tuple <C, l, Ci> in X; i.e., if the extended program implies tuples <C, l, Ci> and <C, l, Di> in X, then Ci and Di denote the same class. When the invented compilation and apparatus process the definition of class C, they collect tuples <C, l, Ci> contributed by the class definition for relation X and verify the semantic restriction for the collected tuples.

For example, the above grammar rules sanction the following definition of class Employee, which inherits class Person. The class definition introduces static superclass Person, dynamic subclass Manager, and label list deptManager, projectManager. It contributes tuples <Employee, deptManager, Manager> and

<Employee, projectManager, Manager> for relation X.

class Employee extends Person dynamic Manager

label [deptManager, projectManager] {

// Class members are omitted.

}

An extended object-oriented program consists of class definitions. The invented compilation compiles the class definitions to binary code, called metadata, in computer memory or in a database. It handles extends, dynamic, and label clauses as follows.

(1) Apply a normal compilation technique to compile the extends clauses in class definitions into a data structure, which records class inheritance relation. Symbol Y will be used to denote the inheritance relation.

(2) Collect tuples <C, l, D> for dynamic classification relation X from the dynamic and label clauses in class definitions. Record the tuples with a data structure.

For an extended program, the invented apparatus takes actions:

Create the data structures mentioned in Steps (1) and (2) for relations X and Y,

Scan the class definitions of the extended object-oriented program, and

Store the tuples of relations X and Y into the data structures, which will be used to support role operations.

For example, FIG. 1 shows the inheritance relation and dynamic classification relation defined by an extended object-oriented program. It uses solid line with hollow arrowhead to denote inheritance. It uses dashed directed line to denote dynamic classification. Dynamic classification link between classes Person and Employee has default label employee. It shows tuple <Person, employee, Employee> in the dynamic classification relation X. Dynamic classification links with common dynamic superclass Employee in FIG. 1 are labeled with identifiers deptManager and projectManager, respectively. They denote tuples <Employee, deptManager, Manager> and <Employee, projectManager, Manager> in relation X. The invented compilation and apparatus collect, transform, and store the dynamic classification relation X.

Dynamic Classification

Nonterminal symbol <class_body> in grammar rule C1 denotes the body of a class definition in an extended program. Like a class body in a normal program, a class body in an extended program consists of data members and member functions, which are also called member variables and methods. The syntax of member variable definition and member function header in an extended program is same as that in a normal program. In an extended program, a (member) function body consists of local variable declarations and statements, some of which dictate role acquisition and relinquishing to objects. The invented compilation and apparatus translate or interpret expressions and statements of role acquisition and relinquishing so that a computer or database system can store and manage the roles. This subsection focuses on role acquisition. The following subsection describes role relinquishing.

In the real world, an entity can be regarded as an instance of a concept. The instance may assume or acquire a role represented by an instance of another concept. The entity may relinquish an acquired role. Role acquisition is viewed as classifying the entity into the concept of the acquired role. Role relinquishing is viewed as declassifying the entity from the concept of the relinquished role. The entity can be classified and declassified into/from several concepts dynamically.

In an extended object-oriented program,

(1) A class can abstract a real-world concept,

(2) An object can represent a real-world entity,

(3) An object may assume and relinquish roles represented with instances of classes, and

(4) Roles assumed by objects may assume and relinquish roles as well.

An object that uniquely represents a real-world entity is called a primary object. Objects that represent roles assumed by objects or roles are called dynamic objects. Both primary and dynamic objects are instances of classes. For simplicity of description, terms role and dynamic object may be used as synonyms.

Various expressions in prior object-oriented languages can create objects in a normal program. They can be used in an extended program to create objects that are designated as primary objects. For example, expression new C ( ) applies operator new to create an object of class C in a normal program. The expression can be used in an extended program to create a primary object, which does not represent a role and which can denote an independent entity in the real world.

Programmers dictate role acquisition to objects with expressions that are produced with the following grammar rules. The expressions in an extended program create dynamic objects, which are different from primary objects. The dynamic objects represent real-world roles assumed by real-world entities.

<dynamic_object_creation> ::= <expression> newChild (

| | <class_name> , <identifier> , <class_name> , <class_name> |
|---|---|
| | ( <arguments> ) |
| \| | <expression> newChild ( <class_name> , <identifier> ) |
| | ( <arguments> ) |
| \| | <expression> newChild ( <identifier> ) ( <arguments> ) |

An expression in format

o0 newchild(C1, l, D1, D0) (arguments)

creates a dynamic object. Expression o0 denotes a primary or dynamic object. Keyword newchild extends the operational semantics of keyword new as follows. Symbols C1, D1 and D0 denote classes. Identifier l is the label of a dynamic classification link between classes C1 and D1. Symbol arguments represents a series of expressions. The newChild expression satisfies conditions:

(i) Object o0 is an instance of a class C0,

(ii) Class C0 inherits class C1 directly or indirectly,

(iii) Class D0 inherits class D1 directly or indirectly,

(iv) Tuple (C1, l, D1) can be found in the data structure storing dynamic classification relation X, and

(v) Expression new D0 (arguments) is valid in a prior language. It can invoke a constructor of class D0 with argument list arguments to create an instance of class D0 in the semantics of the prior language.

The above conditions are paraphrased with respect to the real world as

(a) Object o0 represents a real-world entity that is classified into the concept represented by class C0,

(b) Object o0 is an object of class C1,

(c) An instance of class D0 is an object of class D1,

(d) Object o0 can assume a role represented with an object of class D1.

(e) An instance o1 of class D0 can be created in memory with the prior object creation technique. It is designated as a dynamic object to represent the role.

A programmer applies the newchild expression to classify the entity represented with object o0 into concept denoted with class D0. The dynamic membership of the entity in concept D0 is denoted with the created dynamic object o1.

The invented compilation translates the newChild expression o0 newChild (C1, l, D1, D0) (arguments) to binary code that performs operations:

O1: Apply a prior technique to realize expression new D0 (arguments) so that an instance o1 of class D0 is created in memory, and

O2: Store tuple <o0, o1, <C1, l, D1>> into a data structure.

The invented apparatus interprets the newChild expression by performing Operations O1 and O2.

Operation O1 allocates memory space for creating instance o1 of class D0. The object o1 consists of fields denoted by instance variables defined and inherited by class D0. The fields may be initialized with default values by the prior technology. In terms of prior object-oriented languages, object o1 encapsulates instance functions as well as fields defined and inherited by class D0.

A data structure is used in Operation o2 to store tuple <o0, o1, <C1, l, D1>> that links parent o0 and child o1. The parent-child link is labelled with dynamic classification tuple <C1, l, D1>. Tuples stored in the data structure compose a parent-child relation. The data structure will be called parent-child structure, which satisfies condition:

For an object o0 and a tuple <C1, l, D1> of dynamic classification relation X, the parent-child structure contains at most one tuple <o0, o1, <C1, l, D1>>; i.e., there is at most one parent-child link that has parent o0 and is labelled with <C1, l, D1>.

If the parent-child structure contains a tuple <o0, o2, <C1, l, D1>> for object o2 and an execution of expression o0 newChild(C1, l, D1, D0) (arguments) creates dynamic object o1, Operation O2 substitutes new tuple <o0, o1, <C1, l, D1>> for tuple <o0, o2, <C1, l, D1>> in the parent-child structure. Thus, tuple <o0, o2, <C1, l, D1>> is removed from the parent-child structure. Its removal renders dynamic object o2 a dangling role. The operation for removal of parent-child link between parent o0 and child o2 is specified in the next subsection.

The parent-child structure is used to answer queries:

Q1: For a given primary or dynamic object o0, a class C, and an identifier l, whether the parent-child structure stores a tuple <o0, o1, <C, l, D>>, and

Q2: For a given object o1, whether the parent-child structure stores a tuple <o0, o1, <C, l, D>>.

For a given object o0, Query Q1 requests a child o1 such that the parent-child link between o0 and o1 is labelled with dynamic classification tuple <C, l, D>. If Query Q1 has an answer, the answer must be unique; i.e., if tuples <o0, o1, <C, l, D1>> and <o0, o2, <C, l, D2>> can be found in the parent-child structure, we have o1=o2 and D1=D2. In fact, the tuples in the parent-child structure imply tuples <C, l, D1> and <C, l, D2> in dynamic classification relation X. By the semantic restriction on relation X specified in paragraph 0013 in Subsection 8.2, D1=D2. Since the parent-child structure keeps at most one tuple <o0, o0, <C, l, D1>> for an object o and a tuple <C, l, D1>, o1=o2.

For a given object o1, Query Q2 requests a parent o0. Each dynamic object o1 is created through a newChild expression. A dynamic object o1 has a unique parent. Therefore, if a tuple <o0, o1, <C, l, D>> satisfies Query Q2, it is the only tuple that satisfies Q2 and object o1 has a unique parent o0. This specification of the invented compilation and apparatus ensures invariants:

Each object created in an extended program is either a primary or a dynamic object.

A primary object has no parent recorded in the parent-child structure.

A dynamic object has a unique parent recorded in the parent-child structure.

An implementation of the invented compilation or apparatus can use the parent-child structure to distinguish primary from dynamic objects. It may use an additional data structure to memorize primary or dynamic objects. The binary code generated by the invented compilation and the invented apparatus are responsible to create the parent-child structure, which is initially empty.

In a real-world application, a sentence that dictates a dynamic classification may not convey enough information for a programmer to write a complete newChild expression like o0 newchild(C1, l, D1, D0) (arguments). For example, a saying “Tom is hired” can be coded with expression tom newchild(employee) ( ), which returns a dynamic object e of class Employee, and “Tom is promoted a project manager” can be coded with e newchild(Employee, proj ectManager) ( ) in an extended program. These two newChild expressions follow formats

o0 newChild(l) (arguments)

o0 newChild(C1, l) (arguments)

The binary code generated with the invented compilation and the invented apparatus are responsible to translate expressions

o0 newchild(l) (arguments)

o0 newChild(C1, l) (arguments)

in an extended program to the complete newChild expressions

o0 newChild(C0, l, D0, D0) (arguments)

o₀ newChild(C1, l, D1, D1) (arguments),

respectively. At runtime, they discover the class C0 of object o0. They decide class D0 or D1 such that tuple (<C0, l, D0> or <C1, l, D1> is in dynamic classification relation X. They perform the operations required by the resulting complete newchild expressions.

For example, the invented compilation and apparatus can compile and interpret the newChild expressions in statements

tom :=new GraduateStudent( );

e :=tomnewChild(Person, employee)( );

e newChild(deptManager)( );

e newchild(projectManager)( );

They translate the last newChild expression to expression e newChild (Employee, projectManager, Manager, Manager)( ). They create a primary object tom and three dynamic objects shown in FIG. 2. The above statements use symbol :=as assignment operator. The symbol can be replaced with assignment operator=of some object-oriented languages.

Dynamic Declassification

A real-world entity such as a person may be declassified from a concept such as student after the person completes college education. The declassification can be expressed as the relinquishing of student role by the person entity. The following grammar rule specifies declassification expressions for role relinquishing in extended programs, where nonterminal <expression> denotes an object expression, remove, removeself, and removeAll are keywords.

<declassification> ::=

<expression> remove ( <class_name> , <identifier> ) |
<expression> removeAll | <expression> removeSelf

Assume a role acquisition is coded with expression o0 newChild (C1, l, D1, D0) (arguments), which results in tuple <o0, o1, <C1, l, D1>> in the parent-child structure. A programmer codes the relinquishing of role ol by o0 with declassification expression

o0 remove (C1, l)

in an extended object-oriented program. The binary code generated with the invented compilation for the above expression and the invented apparatus perform actions:

Pose Query Q1 with the given object o0, class C, and identifier l;

If the query returns a tuple <o0, o1, <C, l, D>>, remove the tuple from the parent-child structure and return object o1;

If the query cannot find a tuple, return a null value.

Depending on the object-oriented language extended by the inventions, a null value returned by the last action may be a null pointer or a null reference.

By the comment on Query Q1 in paragraph 0028 of Subsection 8.3, the query returns at most one tuple <o0, o1, <C, l, D>>, which links parent o0 and a child o1. The tuple removal from the parent-child structure renders dynamic object o1 a dangling role, which has no parent recorded in the parent-child structure. An application that implements the invented compilation or apparatus decides how to handle dangling role o1. Options for handling o1 include:

(1) Destruct dynamic object o1 and all the dynamic objects that can be reached from o1 through parent-child links.

(2) Promote dynamic object o1 to a primary object.

The first option amounts to deleting role o1 and all the roles assumed by o1 directly and indirectly from the memory. The second option is useful when the historic role represented by dynamic object o1 needs to be recorded. The binary code generated by the invented compilation and the invented apparatus follow an application decision to handle a dangling role o1 returned by expression o0 remove (C1, l). They handle other expressions that remove tuple from the parent-child structure similarly.

Expression o0 removeAll removes all the parent-child links that designate object o0 as parent. To realize the expression, the binary code generated with the invented compilation for the expression and the invented apparatus perform action:

For each tuple <o0, o1, <C, l, D>> that specifies object o0 as parent in the parent-child structure, execute expression o0 remove (C, l).

Expression o1 removeSelf requires expression o1 denote a dynamic object. Assume dynamic object o1 is linked to its parent o0 through tuple <o0, o1, <C, l, D>> in the parent-child structure. The binary code generated with the invented compilation for the expression and the invented apparatus take actions:

Use object o1 to find a tuple <o0, o1, <C, l, D>> that specifies object o1 as child in the parent-child structure;

Perform actions required by expression o0 remove (C, l). Thus, the role represented by dynamic object o1 is peeled off from the entity represented by the object o1.

Role Data Access

A real-world application may assign values to attributes of roles. For example, when a person is hired, a value must be decided for attribute salary of the employee role. It is nonsense to assign a salary value to other roles such as student assumed by the person. Real-world roles are represented with dynamic objects in extended programs. The dynamic objects encapsulate fields, which store role attribute values.

In a normal object-oriented program, an instance function body may include a special type of field access expression this.a or this→a, where keyword this references or points to an object for which the function is invoked. In some languages, keywords such as self may replace keyword this. If a function body does not declare local variable a, field access expression this.a or this→a can be simplified to expression a in the function body. A prior compilation technique can decide whether expression a represents a local variable or a field. It can be applied to translate field expression a to equivalent qualified expression this.a or this→a. We assume that only expressions in format o.a are used to access a field a in an object o in an extended program. The object expression o may be keyword this.

The following grammar rule specifies the syntax of field access expression o.a, which can be the rvalue (right value) or Ivalue (left value) of an assignment expression. The nonterminal symbol <assignment> represents assignment expressions.

<field_access>::=<expression>.<attribute_name>

<assignment>::=<expression>:=<expression>

For a field access expression o.a and an expression e, the binary code generated with the invented compilation and the invented apparatus handle assignment expression

o.a :=e

by performing actions:

Evaluate expression e, and

Store the value of expression e into field a of object o in memory.

Assume a field access expression o.a and an expression e. In a normal compilation technique, expression

e :=o.a

retrieves field a in object o and assigns the retrieved value to the field or variable represented by expression e. In the invented compilation and apparatus, if object o does not encapsulate field a, the object is regarded as a representative of its children, in which field a is searched for. If the field access o.a cannot be resolved in the children either, field a is searched for in the parent of object o.

The invented compilation and apparatus extend the normal compilation techniques and normal interpreters in processing rvalue expression o.a. Their goal is to reduce user's surprise and ease programmer in coding role data access. Assume a student object s_obj that has an employee role as child, and an employee object e_obj that has a student role. Both the objects s_obj and e_obj could be regarded as instances of the same class EmployeeStudent, which inherits both classes Employee and Student in a language that supports multiple inheritance. When expression s_obj . salary is an rvalue, it retrieves field salary of the employee role. Expression e_obj.salary retrieves field salary in e_obj. Thus, objects s_obj and e_obj behave the same from a user's point of view.

To compile expression o.a that is an assignment rvalue, the parent-child structure is used as a forest. Nodes of the forest represent objects. An arc in the forest connects a parent o0 and a child o1 that are recorded with a tuple <o0, o1, <C, l, D>> in the parent-child structure. Thus, a breadth-first search for an object that encapsulates field a can be conducted starting from object o in the parent-child structure. In the following description, an upward search for field a iterates through the child-parent arcs to find a parent that encapsulates field a.

For an assignment rvalue expression o.a, the invented compilation generates binary code that takes actions:

Look for field a in object o by checking whether the class of object o defines or inherits instance variable a;

If object o has field a, return the value in field a of object o;

If object o does not have field a, execute a breadth-first search for object that encapsulates field a starting from object o in the parent-child structure;

If the above breadth-first search finds exactly one object o1, return the value in field a of the object o1;

If the above breadth-first search finds more than one object, raise an exception;

If the above breadth-first search finds no object, look for field a upwards starting from the parent of object o;

If the upward search finds field a in object o2, return the value in field a of object o2;

If the upward search cannot find field a, return a null value.

For the rvalue expression o.a, the invented apparatus takes the above actions. An application that implements the invented compilation or apparatus may handle the raised exception differently. For example, it can handle the exception by

(1) Returning a null value, or

(2) Randomly selecting an object o3 among the objects found by the breadth-first search and returning the value in field a of object o3.

In a function invocation expression, an argument may be a field access expression o.a. The invented compilation and apparatus handle an argument expression o.a like an assignment rvalue o.a. They also assign the evaluated argument value to the corresponding parameter. Thus, the invoked function can be executed.

In function invocation expression o.a. m (a1, . . . , as), a function m ( ) is invoked for (the object represented by) field access expression o. a. In prior compilation techniques, the subexpression o.a of the function invocation expression is a special argument for the implicit parameter this. As described in the above paragraph, the invented compilation and apparatus can evaluate the argument expression o.a and assign the evaluated value to the implicit parameter this of the invoked function m ( ).

In a real-world application, we may ask whether a given entity is playing some role, and whether a given role is played by some entity. A programmer can code the questions with child and parent access expressions in an extended program. The following grammar rules specify child and parent access expressions for extended programs:

<dynamic_child> ::=

<expression> child <<class_name> , <identifier> >

<dynamic_parent> ::=

<expression> parent <<class_name> , <identifier> >
| <expression> parent

Expression o0 child<C, l> returns a child ol of object o0 such that a tuple <o0, o1, <C, l, D>> is stored in the parent-child structure. Expression o1 parent<C, l> returns parent o0 of child o1 such that a tuple <o0, o1, <C, l, D>> is in the parent-child structure. Expression o1 parent returns parent o0 of child o1 such that a tuple <o0, o1, <C, l, D>> is in the parent-child structure. The invented compilation compiles expressions o0 child<C, l> and o1 parent<C, l>, respectively, to binary code that takes actions:

Find a tuple <o0, o1, <C, l, D>> in the parent-child structure for given object o0 or o1, class c, and identifier l;

Return child object o1 or parent object o0 recorded in the tuple.

The invented compilation compiles expression o1 parent to binary code that takes actions:

Find a tuple <o0, o1, <C, l, D>> in the parent-child structure for given object o1;

Return parent object o0 recorded in the tuple.

For a child or parent access expression, the invented apparatus performs the actions as prescribed above.

Role Method Invocation

In a real-world application, roles can perform operations. For an extended object-oriented program, dynamic objects as well as primary objects are created in memory with the prior techniques and, therefore, they encapsulate functions as well as fields. In the above subsection, a field access expression o.a may retrieve field a in an object o1 different from object o. Due to the same rationality, for a function invocation expression o.m (a1, . . . , as), the binary code generated with the invented compilation or the invented apparatus may execute a function m ( ) encapsulated in an object o1 different from object o. The objects o1 and o represent same real-world entity.

The following grammar rules specify function invocation expressions:

<function_invocation> ::= <expression> . <function_name>

( [ <argument_list> ] * )

<argument_list> ::= <expression> {, <expression> }*

The above grammar rules sanction function invocation expressions o.m (a1, . . . , as) that are used in a normal program. The invented compilation and apparatus may resolve the invoked function m ( ) in children or parent of object o.

For function invocation expression o.m (a1, . . . , as) in an extended program. A function m (T1 p1, . . . , Ts ps) in an object obj can be invoked by the expression o.m(a1, . . . , as) if

The class D of object obj defines or inherits the function m (T1 p1, . . . , Ts ps) such that for each integer i with 1≦i≦s, argument ai can be assigned to parameter pi.

A function m (T1 p1, . . . , Ts ps) in an object obj best fits the function invocation expression o.m(a1, . . . , as) if

(1) Function m (T1 p1, . . . , Ts ps) in object obj can be invoked by expression o.m(a1, . . . , as), and

(2) For each function m (R1 t1, . . . , Rs ts) in object obj that can be invoked by the expression o.m (a1, . . . , as), type Ti is same as type Ri or Ti inherits Ri for each integer i with 1≦i≦s.

The invented compilation translates function invocation expression o.m (a1, . . . , as) to binary code that takes actions:

If a function in object o best fits the expression, execute the function for object o and return the value evaluated by the function as the expression value;

If a function in object o can be invoked by the expression but no function in object o best fits the expression, raise an exception;

If no function in object o can be invoked by the expression, execute a breadth-first search for object in which a function can be invoked by the expression. The search starts from object o in the parent-child structure;

If the above breadth-first search finds exactly one object o₁ and a function in o₁ best fits the expression, execute the function for object o₁ and return the value evaluated by the function;

If the above breadth-first search finds exactly one object o₁ but no function in o₁ best fits the expression, raise an exception;

If the above breadth-first search finds more than one object, raise an exception;

If the above breadth-first search finds no object, look for an object in which a function can be invoked by the expression upwards starting from the parent of object o;

If the upward search finds an object o₂ and a function in o₂ best fits the expression, execute the function for object o₂ and return the evaluated value;

If the upward search finds an object but no function in the object best fits the expression, raise an exception;

If the upward search finds no object, return null value.

In the above description, when the breadth-first search finds more than one object, an exception is raised. A particular implementation of the invented compilation or apparatus can decide how to handle the exception. Options for the exception handling include:

(i) Return a null value as the value of function invocation expression o.m (a₁, . . . , aₛ).

(ii) Randomly select an object o₃ among the objects found by the breadth-first search and decide whether there is a function in o₃ that best fits the expression. If a function in o₃ best fits the expression, execute the function for object o₃ and return the evaluated value; otherwise, raise an exception.

For the function invocation expression o.m (a₁, . . . , aₛ) in an extended program, the invented apparatus performs the above actions.

An implementation of the invented compilation or apparatus may decide not to conduct the breadth search and upward search specified in the above subsection and in this subsection. Thus, when resolving an accessed field or an invoked function in an object o but the object does not encapsulate such a field or function, an exception is raised. The application is responsible to handle the raised exception.

What I claim as my inventions are

1. Compilation of declarations, expressions, and statements of dynamic classification in extended object-oriented programs.

2. Apparatus that can interpret the declarations, expressions, and statements of dynamic classification.
A programmer can use the declarations, expressions, and statements of dynamic classification to
(1) declare dynamic classification relation between classes,
(2) dictate role acquisition to objects,
(3) dictate role relinquishing to objects,
(4) store and visit data in roles, and
(5) invoke functions defined for roles:
The invented compilation can compile the declarations, expressions, and statements to binary code that enables a computer or database system to fulfill the actions intended by the declarations, expressions, and statements. The apparatus enables a computer or database system to execute the actions intended by the declarations, expressions, and statements.
